(19) United States
(12) Patent Application Publication
(10) Pub. No.: US 2011/0179985 A1
(43) Pub. Date: Jul. 28, 2011

(54) VIBRATION-DAMPING PONTOON BOAT MOTOR MOUNT

(76) Inventor: George E. Anderson, Champlin, MN (US)

(21) Appl. No.: 13/011,458

(22) Filed: Jan. 21, 2011

Related U.S. Application Data
(60) Provisional application No. 61/298,810, filed on Jan. 27, 2010.

(51) Int. Cl. B63B 1/12; F16M 13/02

(52) U.S. Cl. 114/61.1; 248/640

(57) ABSTRACT

An improved pontoon boat reduces outboard motor noise and vibration for passengers. A plurality of beams extends between port and starboard pontoons respectively to form a beam matrix to maintain the spacing of the pontoons, to support a deck sheet serving as a floor for the boat, and to support a motor bracket. The beam matrix includes at least a first and preferably a second motor beam, both attached between the port and starboard pontoons. A motor bracket for supporting the outboard motor is attached to and contacts the first and second motor beams only. A motor bracket support may attach the motor bracket to the first and second motor beams. The motor beams, the motor bracket, and bracket support contact only the pontoons, and thus isolate the outboard motor from the deck sheet, the remainder of the beam matrix, and the pontoons.

### CROSS-REFERENCE TO RELATED APPLICATIONS

This is a regular application filed under 35 U.S.C. §111(a) claiming priority, under 35 U.S.C. §119(e)(1), of provisional application Ser. No. 61/298,810, previously filed Jan. 27, 2010, under 35 U.S.C. §111(b).

### BACKGROUND OF THE INVENTION

The present invention deals with pontoon boats, so-called because pontoon hulls provide flotation for the boat. Such boats typically have two or three spaced pontoons in more or less parallel orientation to each other. The term pontoon as used herein means a hollow, watertight, thin-wall, elongate, substantially tubular floatation hull having a streamlined shape that slips through the water with little drag.

Pontoon boats typically include a substantially flat and rectangular deck sheet or plate and a beam matrix comprising a number of beams that support the deck sheet. The beam matrix is attached to or near the top of the pontoons, which support it. The beam matrix forms a frame that rigidly holds the pontoons in the desired orientation and spacing. The deck sheet supports passengers, seats and tables, safety railings, and a control console. The pontoons, deck sheet, and beams usually all comprise aluminum.

The beam matrix typically has one of two configurations. One configuration comprises port and starboard longitudinal edge beams that rest on the pontoons along with crossbeams welded or otherwise fastened to the longitudinal beams. Another configuration has crossbeams only, which are welded or otherwise fastened to the hulls.

A port pontoon extends at least the length of the beam matrix beneath a port edge thereof and is fastened to the beam matrix thereto. A starboard pontoon extends at least the length of the beam matrix beneath a starboard edge thereof and is fastened to the beam matrix thereto.

In some pontoon boats, a third pontoon may be fastened to the underside of the beam matrix and extend at least part way along the length of the deck midway between the port and starboard pontoons. The volume of the pontoons should be sufficient to support the entire loaded weight of the pontoon boat without immersing more than perhaps halfway into the water.

Both beam matrix configurations include a bow crossbeam at front of the boat and a stern crossbeam at the rear. A number of further crossbeams are present between the bow and stern crossbeams to provide sufficient load-bearing for the deck sheet and items that the deck sheet supports. Regardless of the configuration, the beams typically have box or I-beam cross sections. The beam matrix elements all typically comprise sheet or plate aluminum of thickness sufficient to support the load intended for the deck, and to carry the loads the motor creates.

The deck sheet has port and starboard edges in alignment respectively with the port and starboard longitudinal beams, and fore and aft edges in alignment respectively with bow and stern crossbeams. The distance between the port and starboard edges defines the width of the deck sheet. The distance between the fore and aft edges defines the length of the deck sheet. The deck sheet is attached at suitable places to the beam matrix by either welding or by sturdy rivets and connecting brackets.

Usually, a pontoon boat has an outboard motor attached to the beam matrix for propulsion. On most pontoon boats, the outboard motor attaches to a bracket carried on or at least supported by the stern edge beam of the deck midway between the port and starboard joists. On those having a center pontoon, the motor may be attached directly to a bracket carried by that pontoon. Most pontoon boats use an outboard motor typically producing from 30 to 100 hp. Such a motor typically weighs several hundred pounds. The stern edge beam or the middle pontoon and the motor bracket should be strong enough to support the motor and to transmit the motor's motive power.

Outboard motors notoriously create substantial amounts of noise and vibration. Particularly on pontoon boats, the flat and relatively thin deck sheet and rigid beam matrix supporting the deck sheet efficiently transmit the motor noise and vibrations to the passengers. Conventional construction places the large surface area of the deck sheet in relatively direct connection with the motor and transmits noise and vibrations throughout the boat. The large surface of the deck sheet also tends to directly transmit motor noises and vibrations to the passengers. Passengers unsurprisingly find this transmitted motor noise and vibration irritating.

Accordingly, pontoon boat technology has long needed an improved, low cost construction to reduce this noise and vibration.

Many approaches to reducing noise and vibration focus on limiting the amount of noise and vibration produced by the outboard motor. This approach is expensive for a particular amount of noise and vibration reduction. Further, larger pontoon boats have larger motors that increase the amount of noise and vibration, countering any gains in motor quieting technology.

Users often expect that the motor mounted to the vehicle be large enough to quickly propel the vehicle through the water. It is even desirable that the motor have sufficient power to tow people on small floating structures or even for waterskiing.

These multiple objectives are somewhat at odds with respect to one another. Larger and more powerful motors cause more noise and vibration.

Another possible approach attempts to limit the transmission of noise and vibration through the bracket to the deck by using rubber mounts for the bracket. This is not completely successful, because the weight of the motor requires a large and heavy motor bracket that makes efficient damping difficult.

Another possible solution is a layer of noise damping material on the deck sheet bottom to lessen noise and vibration to some extent. This solution will likely require a substantial thickness of damping material in the area of the motor bracket, with perhaps lesser thicknesses more remotely from the motor. This solution adds weight to the boat may have problems relating to adhesion of the damping material and its cost.

Thus, all of these solutions to this problem have deficiencies of one type or another.

### BRIEF DESCRIPTION OF THE INVENTION

The present invention reduces at least a portion of the motor vibration transmitted to the deck, thereby reducing noise and vibration sensed by the passengers of the craft. The invention increases the length of the direct mechanical connection through which noise and high and low frequency vibrations are transmitted to the pontoons and deck, thereby increasing the dissipation of noise and vibration. Further, vibrations first reach the pontoons, whose mass and immersion in water tends to damp noise and vibration.

An improved pontoon boat includes spaced port and starboard pontoons each having a longitudinal axis and a matrix of beams extending between and fastened to the port and starboard pontoons respectively. The beam matrix maintains a predetermined spacing between the pontoons with the pontoon axes substantially parallel, and supports a deck sheet having an aft edge.

The improvement comprises in the beam matrix, at least a first motor beam having a port end fastened to the port pontoon, a starboard end fastened to the starboard pontoon, and an aft edge, said first motor beam spaced from the remainder of the beam matrix and from the deck sheet. One preferred embodiment comprises first and second motor beams spaced from each other and from every other part of the deck matrix and from the deck sheet.

In one version, a motor bracket support is attached to the motor beam or beams between the port and starboard pontoons, and supports the motor bracket. The motor bracket support extends generally parallel to the port and starboard pontoon axes. The motor bracket support is spaced from the deck sheet and from every part of the beam matrix except the motor beams.

The outboard motor is to mount on the motor bracket. The motor bracket may be attached directly to the first motor beam, or if one is present, to the motor bracket support. The motor bracket is spaced apart from the deck sheet, from the pontoons, and from every other part of the deck matrix but the motor beam or the motor bracket support. This arrangement isolates as well as is possible, the motor from components of the craft that can transmit noise and vibration to the passengers.

The motor bracket support may comprise either a structural beam or a third pontoon. A motor bracket support comprising a pontoon may have advantages over a structural beam in that the portion immersed in water may provide additional damping of noise and vibration, while still isolated from the remainder of the deck matrix and from the deck sheet.

Mechanical damping material such as foam may be attached to at least one of the first and if present, second motor beams between the motor bracket support and at least one of the port and starboard pontoons. Preferably, the damping material is attached to both the first and second motor beams between both the port and starboard pontoons and the motor racket support. Damping material may also be attached to the motor bracket support between the first and second motor beams.

In the present invention, the motor beam portions of the beam matrix connect only to the pontoons. Consequently, the motor vibrations carried by the beam or pontoon forming the motor bracket support to which the motor bracket attaches, are mechanically transmitted to only the two outboard pontoons. Much of the outboard motor noise and vibration will be absorbed by the pontoons themselves in view of their mass, metal damping characteristics and water damping. The motor beams, which are not in contact with the deck or remainder of the beam matrix, will flex sufficiently to absorb and damp much of the high frequencies generated by the motor before they reach the outer pontoons. And since substantial fractions of the outer pontoons are immersed, they will effectively damp much of the remaining vibrations.

The remainder of the beam matrix supports the deck sheet and will have only a slight tendency to transmit remaining high frequency “noise” and low frequency “rumble” from the motor. Any vibrations which are transmitted to the deck sheet must pass through the motor beams, the pontoons, and then the portions of the beam matrix between the deck sheet and the pontoons. The mass of the pontoons and their immersion in water tends to damp noise and vibration before reaching the deck sheet. The parts of the deck sheet where passengers are directly in contact with the deck will experience much less noise and vibration.

The pontoons can have virtually any sort of cross-section. It will be further understood that the center structure may be a motor mount (or transom) rather than a complete pontoon designed for flotation. Whether the motor support is a pontoon or motor mount, the motor vibrations will first be transmitted to the outer pontoons and only then can be transmitted to the deck above.

### BRIEF DESCRIPTION OF THE DRAWINGS

FIG. 1 is a top view perspective of a pontoon boat support structure.

FIG. 2 is a rear elevation view of the pontoon boat of FIG. 1.

FIGS. 3 and 4 show in rear elevation views, variants of the structure of FIG. 1.

### DESCRIPTION OF THE PREFERRED EMBODIMENTS

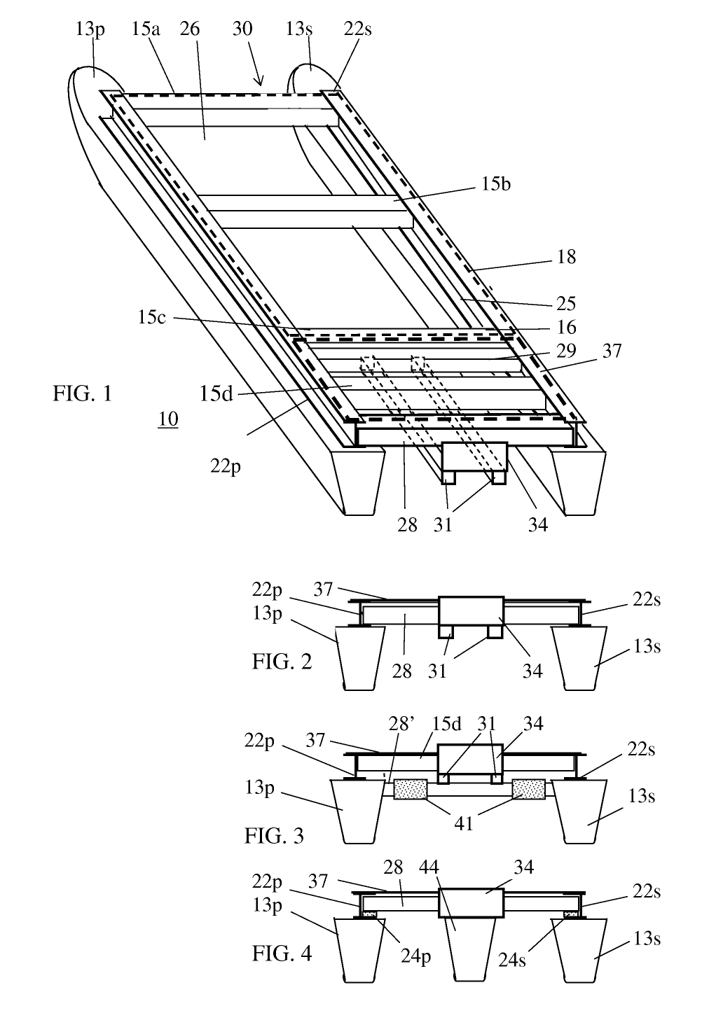

The pontoon boat structure 10 shown by FIG. 1 comprises a substantially planar and rectangular beam matrix 30, and port and starboard pontoons 13p and 13s buoyantly supporting beam matrix 30. Beam matrix 30 and pontoons 13p and 13s typically comprise aluminum, with individual components welded, riveted, or bolted together. Pontoons 13p and 13s are essentially hollow hulls with convenient means for attaching beam matrix 30. Beam matrix 30 supports a deck sheet 18 carrying equipment and passengers.

Beam matrix 30 comprises a matrix or grid of beams that may have a wide variety of configurations. The configuration that FIG. 1 shows has port and starboard longitudinal deck beams 22p and 22s extending lengthwise along pontoons 13p and 13s and crossbeams 15a, 15b, 15c, 15d attached at port and starboard ends thereof to longitudinal beams 22p and 22s. Matrix 30 may include more, perhaps many more crossbeams. Port and starboard beams 22p and 22s are firmly attached to pontoons 13p and 13s by well-known means.

Beams 22p, 22s, 15, and 16 are shown as I beams and beams 15a, 15b, 15c, 15d are shown as box beams, but the beam cross section is not critical so long as the bending strengths are adequate. The port and starboard edges of sheet 18 may even serve as the upper flange of beams 22p and 22s. Typically, beams 22p, 22s, 15, 16, 25, and 26 are welded together. If necessary, further beams may be added as well to support deck sheet 18.

Sheet 18 shown in phantom in FIG. 1 and attached to the upper surface of beams 22p and 22s and crossbeams 15a, 15b, 15c, 15d, provides support for passengers and equipment such as a skipper's station and seats. Sheet 18 must be thick enough and a matrix 30 should have sufficient number of beams to avoid excessive bending when sheet 18 bears the design loads. These are all familiar design considerations for pontoon boats.

A conventional structure 10 has a rear motor bracket 34 attached directly to beam matrix 30 and extending aft for a distance sufficient to allow mounting and supporting an outboard motor. In such a conventional structure, bracket 34 mounts directly on a support beam extending between pontoons 13p and 13s, and which also provides support for the aft edge of a sheet 18 extending the entire length of structure 10. Bracket 34 must have strength sufficient to support the substantial weight of a typical outboard motor and resist the forces and vibration that an outboard motor creates when providing maximum thrust.

The conventional design thus directly attaches the motor bracket 34 support beam close to the deck sheet 18. Motor vibration and noise directly transmits through the support beam to such a deck sheet 18.

A number of various possible embodiments of this invention have structure that mechanically decouples the motor bracket 34 from deck sheet 18. In the FIG. 1 structure 10, an aft deck sheet 37, also shown in phantom, extends between and is supported by the port and starboard beams 22p and 22s and crossbeams 15c and 15d.

First and second motor beams 28 and 29 extend transversely between port and starboard beams 22p and 22s. Beams 28 and 29 are below and importantly, spaced from aft deck sheet 37 and any auxiliary support beams for deck sheet 37. Beams 28 and 29 thus provide no mechanical support for deck sheet 37. Second motor beam 29 is aft of and spaced from crossbeam 15c. First motor beam 28 is spaced from and is aft of crossbeam 15d. Motor beams 29 and 28 may be quite close to the adjacent crossbeams 15c and 15d, but should not touch either.

Deck sheet 37 must not touch motor beams 28 and 29. For this reason, deck sheet 37 may be made of thicker material than deck sheet 18 to prevent sheet 37 from deflecting under load into contact with beams 28 and 29.

More than two motor beams, or only one, may be advantageous in certain situations. The motor beams 28, 29, and any other provided may alternate with cross beams 15a, 15b, 15c, and 15d. When only a single motor beam 28 is present, beam 28 must have strength sufficient to support an outboard motor and transmit its thrust to the entire boat.

A motor bracket support comprises in this embodiment, a pair of spaced third motor beams 31 fastened to the underside of motor beams 28 and 29 and extending fore and aft between pontoons 13p and 13s. Beams 28, 29, and 31 are all shown as box beams. Beams 28 and 29 carry at their aft ends, a motor bracket 34 on which an outboard motor is to be mounted. Beams 28 and 29 must extend sufficiently aft of sheet 37 and other elements of structure 10 to mount the motor and allow the motor to swivel for steering purposes without contacting any part of structure 10. Beams 28, 29, and 31 must be strong enough to support the motor weight and transmit the motor thrust to the entire structure 10.

Auxiliary beams (not shown) providing additional support for aft deck sheet 37 may be placed between and spaced from beams 28 and 29. In fact, the presence of sufficient auxiliary deck sheet support beams between beams 28 and 29 may allow a relatively thin sheet 18 to extend the entire fore and aft length of deck 30, replacing deck sheet 37.

Beams 28, 29, and 31 serve to mechanically isolate bracket 34 from other parts of deck matrix 30 and thus from deck sheet 18 and aft deck sheet 37. The ends of beams 28 and 29 connect solidly to the relatively stiff and heavy pontoons 13p and 13s. The partial immersion of pontoons 13p and 13s in water tend to dampen and absorb noise and vibration. This damping and absorbing of noise and vibration reduces the amount of noise and vibration that sheets 18 and 37 receive from the bracket 34 carrying the outboard motor, thus making the boating experience for passengers much more pleasant.

A first variant of the invention may have only a single motor beam 28. In this case, beam 28 must be quite strong to be able to support

FIG. 2 shows a modified motor bracket support arrangement comprising a single larger and flatter box beam 31′ that may serve as effectively as a pair of beams 31, and may reduce drag in choppier waters as well.

FIG. 3 shows a different configuration for beam 28 (and beam 29, not shown). Beams 28 and 29 attach directly to pontoons 22p and 22s, and beams 31 rest on the top surface of beams 28 and 29. Note that the vertical dimension of crossbeam 15d must be somewhat smaller to avoid contact with beams 31.

In addition, FIG. 3 shows damping material 41 attached to and surrounding a portion of beam 28. Similar damping material may be attached to beams 29 and 31. Such damping material may further reduce the amount of noise and vibration that beams 28, 29, and 31 carry to deck frame 30. The damping material may comprise open or closed cell plastic foam of the appropriate density.

FIG. 4 shows yet another configuration having a center pontoon 44 attached to the undersides of beams 28 and 29. Motor bracket 34 is firmly attached to the aft end of center pontoon 44. The length of pontoon 44 may be similar to that of pontoons 22p and 22s, or may be somewhat shorter. In any case, a motor beam 28 connecting only to pontoons 13p and 13s should be attached near the forward end of pontoon 44.

In this configuration, the motor transmits noise and vibration first to pontoon 44, which is partially immersed in water. This partial immersion of pontoon 44 in a somewhat viscous fluid will of itself provide substantial damping of noise and vibration.

In addition, the added buoyancy that pontoon 44 provides will help support the aft end of structure 10, preventing what is called transom drag. On the other hand, pontoon 44 may reduce maneuverability of the craft to some extent. A pontoon 44 having an overall length shorter than that of pontoons 22p and 22s will tend to maximize buoyancy near the craft's stern, where the heavy outboard motor is located, and therefore prevent transom drag.

FIG. 4 also shows a further noise and vibration damping feature comprising bushings 24p and 24s of appropriate size and formed of a type of mechanical damping material such as rubber of an appropriate durometer rating to both support the weight carried by motor beams 28 and 29 and to efficiently damp noise and vibration. The deck beams 22p and 22s include flanges that fasten to pontoons 13p and 13s. The mechanical damping material comprising bushings 24p and 24s is interposed between the first and second motor beams 28 and 29 and the flanges of the deck beams 22p and 22s that contact pontoons 13p and 13s. Bushings 24p and 24s thus are directly in the path that motor noise and vibration will travel to the deck sheet 18, further reducing the noise and vibration that deck sheet 18 receives.

1. An improved pontoon boat including spaced port and starboard pontoons each having a longitudinal axis and a matrix of beams extending between and fastened to the port and starboard pontoons respectively, said beam matrix maintaining a predetermined spacing between the pontoons with the pontoon axes substantially parallel, and supporting a deck sheet having an aft edge, wherein the improvement comprises:
a) in the beam matrix, at least a first motor beam having a port end fastened to the port pontoon, a starboard end fastened to the starboard pontoon, and an aft edge, said first motor beam spaced from every other part of the deck matrix and the deck sheet; and
b) a motor bracket attached to the first motor beam, for supporting an outboard motor, said motor bracket spaced apart from the deck sheet, from the pontoons, and from every other part of the deck matrix but the first motor beam.

2. The pontoon boat of claim 1, including a motor bracket support attached to the first motor beam between the port and starboard pontoons, and extending generally parallel to the port and starboard pontoon axes, said motor bracket support spaced from the deck sheet and from every part of the beam matrix except the first motor beam and attaching the motor bracket to the first motor beam.

3. The pontoon boat of claim 2 including a second motor beam attached between the port and starboard pontoons and to the motor bracket support, said second motor beam spaced from every other part of the deck matrix and the deck sheet.

4. The pontoon boat of claim 3 wherein the motor bracket support comprises a third pontoon having a longitudinal axis generally parallel to the port and starboard pontoon axes and attached to the first and second motor beams.

5. The pontoon boat of claim 3, including mechanical damping material attached to at least one of the first and second motor beams between the port pontoon and the third pontoon and between the starboard pontoon and the third pontoon.

6. The pontoon boat of claim 3, wherein the beam matrix includes port and starboard deck beams attached to the port and starboard pontoons respectively and extending longitudinally along the pontoons, and the first and second motor beams are attached through the deck beams to the port and starboard pontoons, said first and second motor beams spaced apart from every other element of the beam matrix and the deck sheet.

7. The pontoon boat of claim 6, including mechanical damping material attached to the first motor beam between at least one of the port pontoon and the motor bracket support and the starboard pontoon and the motor bracket support.

8. The pontoon boat of claim 3 wherein the motor bracket support comprises a third pontoon having a longitudinal axis generally parallel to the port and starboard pontoon axes and attached to the first and second motor beams.

9. The pontoon boat of claim 3, wherein said first motor beam has the port and starboard ends thereof directly attached respectively to the port and starboard pontoons.

10. The pontoon boat of claim 3, wherein the motor bracket support projects past the deck sheet's aft edge.

11. The pontoon boat of claim 10, wherein the motor bracket support comprises a pair of spaced elements attached to the first and second motor beams.

12. The pontoon boat of claim 1, including a second motor beam having a port end fastened directly to the port pontoon and a starboard end fastened directly to the starboard pontoon, said second motor beam spaced from every other part of the deck matrix and the deck sheet.

13. The pontoon boat of claim 12, wherein the beam matrix includes port and starboard deck beams attached to the port and starboard pontoons respectively and extending longitudinally along the pontoon axes, and the first and second motor beams are attached through the deck beams to the port and starboard pontoons.

14. The pontoon boat of claim 13, wherein the deck beams include flanges attached to the pontoons, said boat further including mechanical damping material interposed between the first and second motor beams and the deck beam flanges.

15. The pontoon boat of claim 12, including mechanical damping material attached to at least one of the first and second motor beams between at least one of the port pontoon and the motor bracket support and the starboard pontoon and the motor bracket support.
